(19) United States
(12) Patent Application Publication
(10) Pub. No.: US 2026/0170783 A1
(43) Pub. Date: Jun. 18, 2026

(54) ADAPTIVE CONFIGURATION FOR VIRTUAL CONTENT BASED ON SURFACE DEPTH

(71) Applicant: GOOGLE LLC, Mountain View, CA (US)

(72) Inventors: Hagar Adler, Seattle, WA (US); Björn Nicolaas Servatius Vlaskamp, Seattle, WA (US)

(21) Appl. No.: 19/423,187

(22) Filed: Dec. 17, 2025

Related U.S. Application Data
(60) Provisional application No. 63/735,737, filed on Dec. 18, 2024.

(51) Int. Cl. G06T 19/20; G02B 27/01; G06F 3/01

(52) U.S. Cl. CPC G06T 19/20; G02B 27/017; G06F 3/013; G06T 2219/2016

(57) ABSTRACT

Implementations for adaptive configuration of virtual content based on surface depth are described herein. For example, an illustrative method includes determining a distance from a display device to a surface visible in a region of a field of view of the display device, the surface being associated with virtual content to be displayed. Based on the distance, a configuration (such as a size) for the virtual content is determined, the configuration defined such that a depth of field for the virtual content extends at least from the surface to a focal plane at which the virtual content is to be displayed. The display device then displays the virtual content at the focal plane with the determined configuration (with the determined size). This adaptive scaling helps keep the virtual content in focus for users viewing real-world surfaces to improve visual comfort. Corresponding methods, apparatuses, and non-transitory computer-readable media are also disclosed.

### CROSS REFERENCE TO RELATED APPLICATION

This application claims the benefit of U.S. Provisional Application No. 63/735,737, filed Dec. 18, 2024, the disclosure of which is incorporated herein by reference in its entirety.

### BACKGROUND

Extended reality (XR) devices, such as virtual reality (VR) headsets and augmented reality (AR) glasses, are increasingly utilized in various applications to provide users with immersive digital experiences. Many such devices, particularly in the AR space, include see-through displays and associated optical elements, such as waveguides and lenses, that are configured to combine a user's view of a real-world environment with computer-generated virtual content. A primary goal in the design of such devices is to present the virtual content in a manner that is clear, stable, and comfortable for a user to view, even during prolonged use. The quality of the optical systems and the methods used to render content on the displays can significantly impact a user's experience and the overall effectiveness of the device in seamlessly blending virtual and real-world views.

### SUMMARY

Systems and methods are disclosed herein for adaptive configuration (e.g., scaling) of virtual content presented by an extended reality (XR) device. A technical problem can arise in see-through XR devices where virtual content is presented at a fixed focal distance, while a user may be viewing the content overlaid on real-world surfaces at various other distances. This mismatch can require the user to constantly re-accommodate (i.e., exert effort to refocus) their eyes when shifting their gaze, which can lead to visual fatigue and discomfort. To address this, technical solutions described herein determine a distance to a real-world surface that is to be overlaid by the virtual content. Based on this distance, a configuration such as a size or scale for the virtual content is determined. The determined configuration is configured such that a depth of field for the virtual content extends from the surface to the fixed focal plane. As a technical effect, this improves visual comfort in a computationally efficient manner without requiring complex, variable-focus optical hardware.

In some aspects, the techniques described herein relate to a method including: determining a distance from a display device to a surface visible in a region of a field of view of the display device, the region being associated with virtual content to be displayed by the display device; determining, based on the distance, a configuration for at least a portion of the virtual content, the configuration being defined such that a depth of field for the virtual content extends at least from the surface to a focal plane at which the virtual content is to be displayed; and displaying, by the display device, the virtual content at the focal plane with the configuration determined based on the distance.

In some aspects, the techniques described herein relate to an apparatus including: a plurality of emitters configured to generate light representing virtual content; a waveguide configured to manipulate the light generated by the plurality of emitters to display the virtual content at a focal plane; and a controller configured to: determine a distance to a surface visible in a region of a field of view of the apparatus, the region being associated with virtual content to be displayed by the apparatus; determine, based on the distance, a configuration for at least a portion of the virtual content, the configuration being defined such that a depth of field for the virtual content extends at least from the surface to the focal plane; and control the plurality of emitters to display the virtual content at the focal plane with the configuration determined based on the distance.

In some aspects, the techniques described herein relate to a non-transitory computer-readable medium storing instructions that, when executed, cause a controller of a display device to perform a process including: determining a distance from the display device to a surface visible in a region of a field of view of the display device, the region being associated with virtual content to be displayed by the display device; determining, based on the distance, a configuration for at least a portion of the virtual content, the configuration being defined such that a depth of field for the virtual content extends at least from the surface to a focal plane at which the virtual content is to be displayed; and causing the display device to display the virtual content at the focal plane with the configuration determined based on the distance.

Various implementations, such as methods, systems, and computer-readable media, are disclosed herein. It will be understood that these various implementations are not mutually exclusive. For example, operations described in the context of a method may be performed by a suitably configured system, and a system may be configured to perform operations described as part of a method. Similarly, instructions stored on a computer-readable medium may cause a system to perform a disclosed method. Further details of these and other implementations are set forth in the accompanying drawings and the description below.

### BRIEF DESCRIPTION OF THE DRAWINGS

FIG. 1 shows an illustrative implementation of adaptive scaling for virtual content based on surface depth in accordance with principles described herein.

FIG. 2 shows a flowchart for an illustrative method implementing adaptive scaling for virtual content based on surface depth in accordance with principles described herein.

FIG. 3 shows a block diagram of an illustrative display device configured for adaptive scaling for virtual content based on surface depth in accordance with principles described herein.

FIG. 4 shows an illustrative environment for implementing adaptive scaling for virtual content based on surface depth in accordance with principles described herein.

FIG. 5A shows aspects of an illustrative technique for determining a surface depth for adaptive scaling in accordance with principles described herein.

FIG. 5B shows aspects of another illustrative technique for determining a surface depth for adaptive scaling in accordance with principles described herein.

FIG. 6 shows an illustrative diagram of a relationship between virtual content size and depth of field in accordance with principles described herein.

FIG. 7 shows a first illustrative scenario related to adaptive scaling for virtual content in which the virtual content is scaled up for a near surface in accordance with principles described herein.

FIG. 8 shows a second illustrative scenario related to adaptive scaling for virtual content in which the virtual content is scaled up for a far surface in accordance with principles described herein.

FIG. 9 shows a third illustrative scenario related to adaptive scaling for virtual content in which the virtual content is scaled down for optimization in accordance with principles described herein.

FIG. 10 shows a block diagram of an illustrative computing system for implementing adaptive scaling for virtual content based on surface depth in accordance with principles described herein.

### DETAILED DESCRIPTION

Extended reality (XR) devices, such as smart glasses, may be configured to overlay virtual content (e.g., computer-generated content) onto a user's view of the real world. A technical challenge with these devices may arise, however, when that virtual content is presented at a single, fixed focus distance (e.g., appearing to be six feet away), while real-world objects visible through the display are at various distances. When a user tries to view virtual information on a nearby object (e.g., reading a virtual translation on a physical menu held a few inches from their eyes), their eyes must constantly work to refocus between the close-up surface (e.g., the menu, in this example) and the farther-away virtual text. This can cause eye strain and visual fatigue. To address these issues, technical solutions described herein intelligently adjust a size of the virtual content based on the distance to the real-world surface it overlays. While it might seem intuitive to scale content down for nearby surfaces to match perspective, technical solutions described herein leverage a different optical principle: that larger objects have a greater depth of field (i.e., they appear sharp across a wider range of distances). Accordingly, the described solutions may, in a somewhat counter-intuitive manner, scale up the size of the virtual content when it is overlaid on a nearby surface. This size increase expands the content's depth of field, allowing it to appear sharp and clear to a user focused on the nearby surface without requiring the user to constantly re-accommodate (i.e., refocus) their eyes.

The technological context of implementations described herein, as well as various technical problems they address, technical solutions they propose, and technical benefits they provide, will now be described in more detail.

Systems and methods described herein are situated in the general technological field of extended reality (XR) devices (which include augmented reality (AR) and virtual reality (VR) systems) and possibly other types of device with see-through displays (and optical see-through (OST) displays, in particular). For example, illustrative implementations relate to see-through display devices such as AR glasses, which may be configured to blend computer-generated virtual content with a user's view of their real-world environment. To achieve this, such devices typically incorporate a set of core components, including one or more display panels (e.g., micro light-emitting diode (microLED) panels), and one or more optical elements (e.g., waveguides, lenses, etc.) positioned to direct light from the display panels toward a user's eyes. These optical elements may be configured to form a virtual image of the content that appears stable and is viewable at a comfortable distance.

A significant technical problem arises in the design and operation of these see-through display devices from a fundamental mismatch between the device's optics and the natural function of the human visual system. The optical elements of a typical AR device may be designed to present virtual content at a single, fixed focal plane, causing the virtual content to appear at a fixed distance from the user (e.g., two meters away). However, in a real-world environment, a user's attention may constantly shift between objects at a wide variety of distances, from a handheld object at 30 centimeters to a person across the room at four meters. When virtual content is intended to overlay or be associated with a real-world object, a discrepancy between the fixed focal distance of the virtual content and the actual distance of the real-world object can occur.

This discrepancy forces the user's visual system to exert constant effort to resolve conflicting depth cues. The human visual system uses a variety of physiological actions to perceive depth and maintain focus. One of these actions is referred to as accommodation, which is the process by which the ciliary muscles in the eye contract or relax to change the shape of the eye's lens, thereby adjusting its focal power to bring an object at a certain distance into sharp focus on the retina. Other such actions that help the eye to perceive depth could include an assessment of blur at a particular accommodation level, the amount of vergence (the process by which both eyes rotate inward by a certain amount to align their gaze on an object) needed to focus on a particular object, and so forth.

The technical problem of accommodation fatigue becomes particularly acute in these AR devices. If a user wearing an AR device with a focal plane fixed at two meters looks at a physical menu held at 30 centimeters, their accommodative system adjusts the eye's lens to bring the nearby menu into focus. However, to see the virtual content overlaid on that menu, the eye must then try to re-accommodate for the two-meter distance of the focal plane. This requirement to constantly and rapidly re-accommodate when shifting gaze between the real-world surface and the virtual overlay places significant strain on the eye's ciliary muscles. This sustained effort can lead to significant visual fatigue, eye strain, headaches, and general discomfort, degrading the user experience. Furthermore, this depth mismatch can be visually disorienting, as the human brain expects a nearby object to occlude, or block, more distant content. When virtual content that appears to be two meters away is not blocked by a menu held at 30 centimeters, it can break the user's sense of immersion.

This technical problem is exacerbated in certain types of devices, particularly monocular AR devices that present virtual content to only one of the user's eyes. While a binocular system can leverage stereoscopic rendering to create some illusion of depth for virtual objects, a monocular system lacks these binocular vergence cues. As a result, the fixed nature of the focal plane may be more apparent in a monocular device, and the burden of resolving the depth mismatch falls almost entirely on the viewer's accommodation of the content and related phenomena such as the blur that is perceived.

Conventional solutions for addressing this technical problem have generally focused on complex hardware-based approaches, which introduce significant drawbacks of their own. One conventional solution involves implementing variable-focus optics, such as mechanical systems with physically moving lenses (varifocal systems) or liquid crystal lenses that can be electronically switched between a few discrete focal planes (multifocal systems). While theoretically capable of adjusting the focal plane to match the user's point of gaze, these systems are often bulky, heavy, expensive, slow to respond, and power hungry. These characteristics tend to be contrary to design goals of creating XR devices that are lightweight, power-efficient, and can be worn comfortably all day.

Another conventional solution involves the use of a “push-pull” optical system. In many AR devices, the native focus of the display optics is at infinity. A “pull” lens is thus used to bring the virtual content from infinity to the desired fixed focal distance (e.g., two meters). However, as this lens also affects the view of the real world, a second “push” lens is typically coupled with the pull lens to cancel out the optical power of the first lens for the real-world view, keeping it undistorted. This push-pull system, while functional, adds significant hardware complexity, cost, and weight to the device. The precise alignment and manufacturing tolerances required for these lenses can also lead to lower production yields and introduce other optical artifacts, making this an expensive and difficult conventional solution to implement effectively.

To overcome the limitations of these conventional hardware-based approaches, technical solutions described herein provide a computationally efficient, software-based method for mitigating accommodation-related eye strain. These technical solutions are based on leveraging a natural and inherent optical property of the human eye itself: the relationship between the size of a viewed object and its perceived depth of field. As will be further described and illustrated below, the eye's depth of field (the range of distances over which an object appears acceptably sharp) is dependent on the object's size and spatial frequency. Larger objects (i.e., objects with lower spatial frequencies), have a greater depth of field than smaller, more detailed objects (i.e., objects with higher spatial frequencies). Implementations described herein therefore use this natural optical effect to adjust the effective depth of field of virtual content by controlling and modifying its size, without physically altering the device's optics.

The modification of the size of the virtual content, as described above, may be understood as one example of modifying a “configuration” of the virtual content to achieve the desired depth of field effect. While determining and/or modifying the size or scale of the content is a primary and effective implementation, the broader concept of determining and/or modifying a configuration may also include adjusting other visual properties of the content. For example, in some implementations, the configuration may also or alternatively include adjusting a level of blur applied to the content, modifying its contrast, or changing other geometric properties beyond simple scaling. For the sake of clarity and simplicity in the following descriptions, the focus will be on implementations where the configuration being determined or modified is the size of the virtual content. However, it will be understood that this is a non-limiting example of the broader principle of determining or modifying a content configuration to control its depth of field.

Technical solutions described herein involve a novel process in which a display device first determines the distance to a real-world surface that is to be at least partially overlaid by virtual content. The device then determines a size for the virtual content based on the measured surface distance and the device's fixed focal distance. Specifically, if the dioptric difference between the surface and the focal plane is large, the device determines a size for the virtual content that is greater than a default size. This leverages the principle that larger objects have a greater depth of field, causing the depth of field for the virtual content to expand until it is large enough to encompass both the surface and the focal plane. This allows the virtual content to appear sharp to an eye that is accommodated for the real-world surface.

To implement these technical solutions, the display device must first determine the distance to the relevant real-world surface. This can be accomplished through several techniques. In some implementations, an outward-facing depth sensor, such as a time-of-flight (ToF) sensor or a stereo camera pair, may be used to generate a depth map of the environment. A controller can then identify the distance to the specific surface (within the environment and visible in the current field of view of the device) that the virtual content is intended to overlay. This approach is powerful as it can be implemented based on occlusion cues without necessarily needing to track the user's specific point of gaze. In certain implementations (e.g., those with binocular see-through displays), a binocular eye-tracking system may be used to determine the user's point of focus and/or to calculate the vergence angle of the eyes, which may then be used to infer the distance to the object of focus.

Technical solutions described herein provide a variety of advantageous technical effects. A primary technical effect is a significant improvement in user comfort. By digitally ensuring the depth of field of the virtual content is always large enough to encompass the user's natural accommodation state, the system directly mitigates the need for constant, fatiguing re-accommodation. This makes the device more comfortable to use for extended periods. Another technical effect is the solutions'high computational efficiency. The process of determining a size scaling factor is a lightweight computational task compared to conventional solutions like real-time ray tracing or dynamic optical adjustment, making it ideally suited for the constrained processing and power budgets of mobile, battery-powered AR devices.

A further, significant technical effect is the potential for hardware simplification and cost reduction. By managing the depth of field of virtual content in software, technical solutions described herein may, in certain implementations, reduce the need for complex and costly conventional hardware, such as the varifocal or multifocal systems described above. While the native focus may still be set by a system such as a push-pull lens system, avoiding the need for active, variable-focus components can lead to a display device that is lighter, thinner, less complex, and cheaper to manufacture, with improved production yields. This may allow for a more robust hardware design and can also support a larger diopter range for users who require vision correction.

Certain terminology used in this description may be understood in the following sense to aid in describing principles set forth herein. These definitions are provided as examples and are not intended to be limiting; they may be added to and/or further defined and clarified by the examples described herein.

As used herein, a “display device” or “apparatus” may refer to an electronic system configured to present visual information to a user. Such a device may be implemented as a head-mounted extended reality (XR) device, such as augmented reality (AR) glasses or a virtual reality (VR) headset. “Virtual content” may refer to any computer-generated visual information, such as text, images, animations, or graphical user interface elements, that is intended to be displayed by a display device. As used herein, a “surface” may refer to a boundary of a real-world object within an environment that is visible to a user or detectable by a sensor of a display device. A surface may be planar, such as a wall, or may have a complex, non-planar geometry, such as the surface of a person's face or an irregularly shaped piece of machinery.

As used herein, the “pose” of a device may refer to its position and orientation in a three-dimensional space. As used herein, “manipulating an object” may refer to a user performing a physical interaction with an object, such as by handling, assembling, repairing, inspecting, or otherwise interacting with the object as part of a task.

A “focal plane” may refer to a plane in space at which an optical system is configured to form a sharp virtual image of content. For many XR devices described herein, the focal plane may be at a fixed distance from the display device. As used herein, “distance” may refer to a measurement of separation between two points, planes, or objects. The term may refer to a direct line-of-sight measurement from a component of a display device (e.g., a sensor) to a surface, or it may be a calculated or effective distance that accounts for various offsets, such as the distance from a user's eye to the surface, which may be derived from sensor data and known device geometry. For a complex or non-planar surface, the distance may be an average, minimum, or otherwise representative distance to the portion of the surface being overlaid by virtual content.

In implementations described herein, a surface may be located within a “region” of the field of view associated with the virtual content. This region refers to the specific area within the display's overall field of view where the virtual content is intended to be presented. This region is therefore associated with the virtual content in that it is the designated location for that content. A surface visible within this region is thus a surface that the virtual content is intended to appear in front of. In other words, a surface visible within a region of the field of view associated with the virtual content will be understood to be a surface that is to be at least partially overlaid by the virtual content from the user's perspective.

As used herein, a “depth of field” may be measured in units of distance (e.g., meters) and may refer to the range of distances from a user's eye (e.g., the range in object space) within which virtual content will appear to be in focus (e.g., acceptably sharp to the user) without the user needing to re-accommodate their eye. This concept is noted to relate to the term “depth of focus,” which may be measured in units such as diopters and represents a range behind the lens over which the image appears sharp. As used herein, the “size” of virtual content may refer to a physical dimension of the content as rendered on a display (e.g., a height or width in pixels or millimeters) or an angular size as perceived by a user (e.g., in degrees of visual arc). A “default size” may refer to a baseline or nominal size for a piece of virtual content before any adaptive scaling is applied, such as the size the content would have when an overlaid surface is at or near the focal plane. A “scaling value” may refer to a value, received from a data store, that is used to determine the size for the virtual content. A “diopter” may refer to a unit of measurement of the optical power of a lens or curved mirror, which is equal to the reciprocal of the focal length measured in meters. A “dioptric difference” may therefore refer to a difference in optical power between two focal distances.

As used herein, “spatial frequency” may refer to a characteristic of an image or object related to its level of detail. A high spatial frequency may correspond to fine details, sharp edges, or small patterns, while a low spatial frequency may correspond to coarse details, large uniform areas, or blurry edges. The relationship between depth of field and object size is related to spatial frequency, as larger objects are generally perceived as having lower spatial frequencies and thus a greater depth of field.

As used herein, a “depth sensor” may refer to a hardware component configured to measure the distance to objects and surfaces in an environment. For example, a “time-of-flight sensor” refers to a specific type of depth sensor that may operate by emitting a signal and measuring the time it takes for the signal to reflect off a surface and return. An “eye tracking system” may refer to a system of sensors (e.g., inward-facing infrared cameras, etc.) and logic configured to monitor the position, orientation, and/or movement of a user's eye or eyes. A “vergence angle” may refer to the angle formed between the lines of sight of a user's two eyes as they converge to focus on an object, with the angle being inversely proportional to the object's distance.

As used herein, “emitters” may refer to individual light-generating components of a display panel, such as micro light emitting diodes (microLEDs), which are an emissive technology characterized by its microscopic size. A “monochrome panel” may refer to a display panel or an array of emitters in which all of the emitters are configured to generate light of a same single primary color (e.g., all green). A “waveguide” may refer to an optical element designed to guide and manipulate light from the emitters toward a user's eye. A “diffractive waveguide,” in particular, is used herein to refer to a specific type of waveguide that uses diffractive optical elements (e.g., gratings) to manipulate the light. A “monocular display device” may refer to a display device configured to present virtual content to only one of a user's eyes, while a “binocular display device” may refer to a display device configured to present virtual content to both eyes concurrently. A “push-pull lens system” may refer to a conventional optical assembly in some AR devices, typically comprising a “pull” lens to adjust the focus of virtual content and a “push” lens to cancel out the optical effect on the real-world view.

As used herein, a “controller” may refer to a processing unit, such as a central processing unit (CPU), graphics processing unit (GPU), or application-specific integrated circuit (ASIC), that is configured to execute instructions and orchestrate the operations of a device. A “non-transitory computer-readable medium” may refer to any tangible medium capable of storing instructions that can be executed by a controller. Examples may include random-access memory (RAM), read-only memory (ROM), flash memory, and magnetic or optical disks.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods for adaptive scaling for virtual content based on surface depth may result in any or all of the technical effects mentioned above, as well as various additional and/or alternative technical effects and benefits that will be described and/or made apparent below.

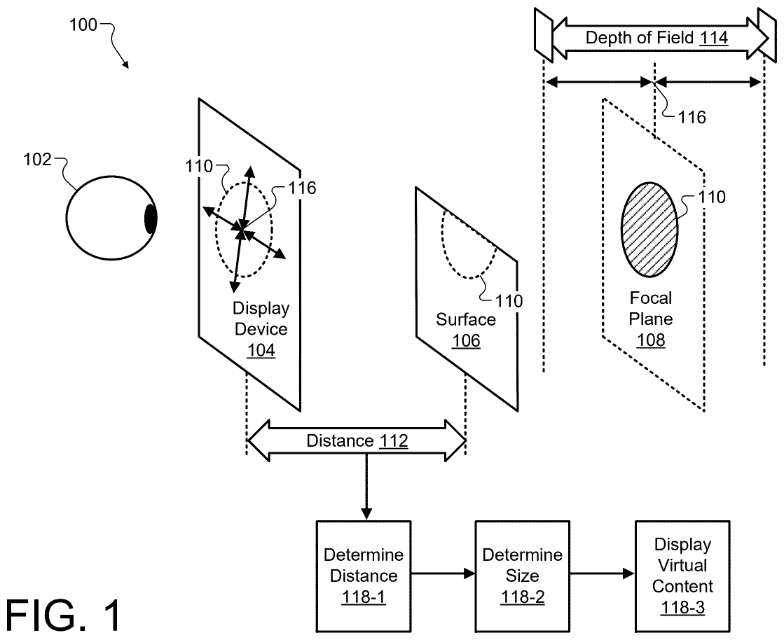

FIG. 1 shows an illustrative implementation 100 for adaptive scaling for virtual content based on surface depth in accordance with principles described herein. Implementation 100 provides a high-level conceptual overview of certain components, spatial relationships, and a process that may be used to mitigate accommodation-related visual fatigue. The figure depicts an eye 102, which may represent an eye of a user who is viewing a scene that includes a combination of real-world objects and virtual content.

As shown, implementation 100 includes a display device 104, a surface 106, a focal plane 108, and virtual content 110. Display device 104 may be implemented as an extended reality (XR) device, such as a pair of augmented reality (AR) glasses or another type of head-mounted display, that is configured to present virtual content 110 to eye 102. Surface 106 may be a surface of a real-world object within an environment visible to the user (e.g., a menu onto which virtual text such as a language translation is to be overlaid). In operation, virtual content 110 may be presented by display device 104 at focal plane 108, though it is intended to appear to the user as being at least partially overlaid on surface 106. For this reason, as shown, while the full circle representing virtual content 110 is optically formed at focal plane 108, a portion of it is perceived by eye 102 as being overlaid on surface 106.

Implementation 100 further illustrates certain spatial relationships and concepts that are central to the technical solutions described herein. The figure depicts a distance 112, which represents the distance from display device 104 to surface 106. The figure also depicts a depth of field 114, which represents the range of distances over which virtual content 110 will appear acceptably sharp to eye 102. A key technical insight is that the extent of depth of field 114 is dependent on a size 116 of virtual content 110. To illustrate this, the concept of size 116 is shown in two ways in the figure. First, size 116 is shown on display device 104 itself, where the scalable borders of virtual content 110 indicate that its physical or angular size can be made larger or smaller. This scaling of the content affects the size of the virtual image that is formed at focal plane 108 and perceived by eye 102. Second, size 116 is also illustrated by the arrows that show the extent of depth of field 114. This second illustration shows the technical effect of the first: as the size of virtual content 110 is adjusted, the corresponding depth of field 114, which may be centered on focal plane 108, expands or contracts. Implementations described herein leverage this relationship by determining the size 116 for virtual content 110 such that its corresponding depth of field 114 is large enough to extend at least from focal plane 108 to surface 106, thereby bridging the gap between them and allowing both to be viewed in focus simultaneously.

To address the technical problem of accommodation fatigue, implementation 100 includes a process, illustrated by the flowchart at the bottom of the figure, that is configured to determine and apply a size to virtual content 110 to improve visual comfort. The process begins at an operation 118-1, where a controller of display device 104 may perform an operation of determining a distance from the display device to a surface that is to be at least partially overlaid by the virtual content (e.g., distance 112 to surface 106).

The process continues at an operation 118-2, where the controller performs an operation of determining, based on the distance, a size for the virtual content. This operation involves selecting a specific size for virtual content 110 (e.g., size 116) that is calculated to produce a depth of field (e.g., depth of field 114) that extends at least from surface 106 to focal plane 108. It will be understood that FIG. 1 conceptually illustrates this goal, though the figure shows that depth of field 114 currently does not extend all the way to surface 106 (the desired end state of the operation). As such, it will be understood that, if an initial depth of field associated with a default size of the content is shown (which does not reach surface 106), operation 118-2 may involve determining a larger size for the virtual content to cause the depth of field to expand until it encompasses surface 106, as will be further illustrated in later figures.

The process then concludes at an operation 118-3, which illustrates an operation of displaying, by the display device, the virtual content at the focal plane with the size determined based on the distance. This results in the user perceiving virtual content 110 as being sharp and comfortable to view when their eye 102 is accommodated for the real-world surface 106.

Display device 104 may be any suitable apparatus configured to perform the methods described herein. For example, display device 104 may be a head-mounted display that includes a see-through display, allowing a user to view both virtual content 110 and their real-world environment, including surface 106. In some implementations, display device 104 may be a monocular display device configured to present virtual content to a single eye of a user, which is a context where the technical solutions described herein are particularly beneficial. In other implementations, display device 104 may be a binocular display device configured to present content to both eyes of a user.

Surface 106 may be any surface within the field of view of display device 104. For example, surface 106 could be the surface of a nearby object, such as a book a user is reading or a tool they are using, or it could be a more distant surface, such as a wall or a sign across a room. In one example, mentioned above, surface 106 could be a surface of a menu onto which virtual text (e.g., a translation, nutritional information, etc.) is to be superimposed. Virtual content 110 may be any form of computer-generated information intended to augment the user's view of the real world. For example, virtual content 110 could be textual information (such as instructional text), graphical overlays (such as instructional arrows pointing to features on surface 106), or user interface elements.

To provide a more concrete example, consider a scenario where display device 104 is a pair of AR glasses and surface 106 is the surface of a physical menu being held by a user. In this implementation, distance 112 from display device 104 to surface 106 might be approximately 40 centimeters. The optical system of display device 104 may be configured to present virtual content at a fixed focal plane 108, with the distance to the focal plane being approximately two meters. The virtual content 110 in this scenario could be a real-time translation of the menu text, which is to be overlaid on the physical menu.

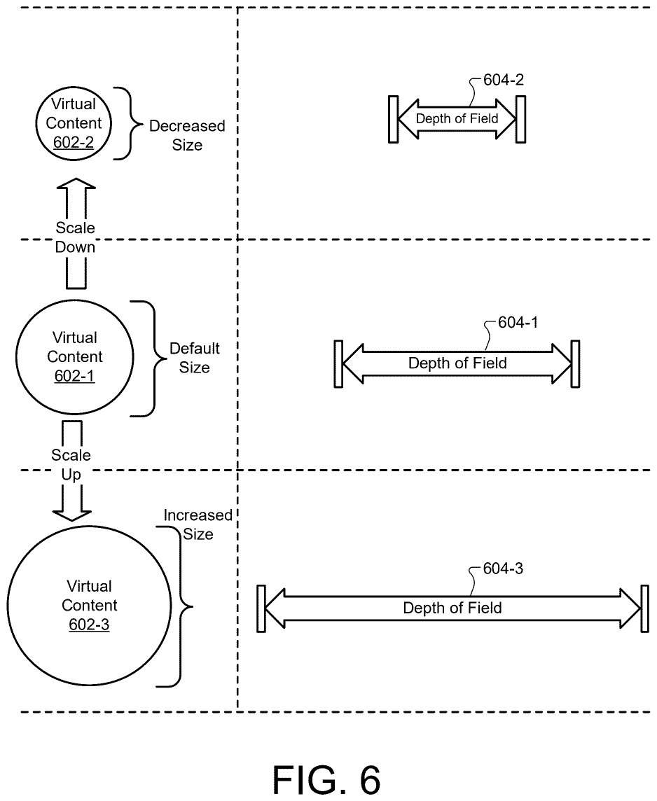

In this example scenario, the process would be performed as follows. At operation 118-1, a controller of display device 104 would determine the distance 112 to surface 106 (40 cm). Because surface 106 is much closer than focal plane 108 (200 cm), the user's eye 102 will be accommodated for the near distance. At operation 118-2, the controller, based on this large dioptric difference, would determine a size 116 for virtual content 110 that is greater than a default size. This leverages the natural optical properties of the eye, as described in more detail below with reference to FIG. 6. Finally, at operation 118-3, display device 104 would display the translated text (virtual content 110) with the determined larger size, causing it to have a wider depth of field 114 that allows it to appear sharp and clear to the user without requiring them to re-accommodate their eye.

In summary, FIG. 1 illustrates a foundational implementation and process for improving user comfort in a see-through display device. By determining a distance to a real-world surface, and then determining and displaying a size for virtual content based on that distance to expand the content's depth of field, the system can effectively mitigate the eye strain associated with accommodation fatigue. This provides a high-level overview of the technical solutions that will be described in more detail in the figures that follow.

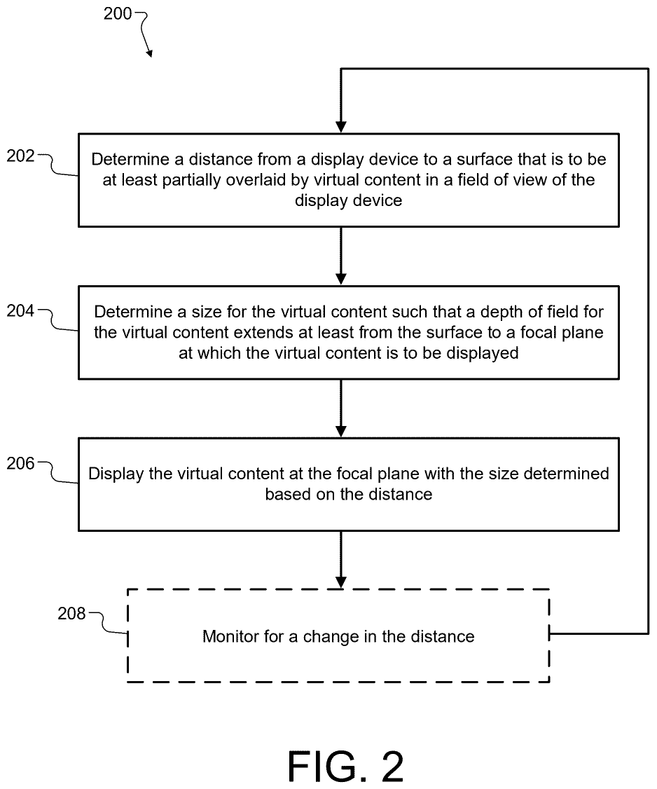

FIG. 2 shows a flowchart for an illustrative method 200 implementing adaptive scaling for virtual content based on surface depth in accordance with principles described herein. Method 200 provides a step-by-step illustration of one illustrative process that may be performed to address the technical problem of accommodation fatigue that has been described. The operations of method 200 may be performed by a display device described herein (e.g., display device 104 from FIG. 1), and may be executed by a controller of such a device based on instructions stored in a memory. While method 200 is shown with operations in a particular order for illustrative purposes, it will be understood that other implementations may reorder, add to, or omit certain operations. Furthermore, while the arrows may suggest a sequential order, it will be understood that some operations may be performed concurrently or in different orders. Each of the operations of method 200 will now be described.

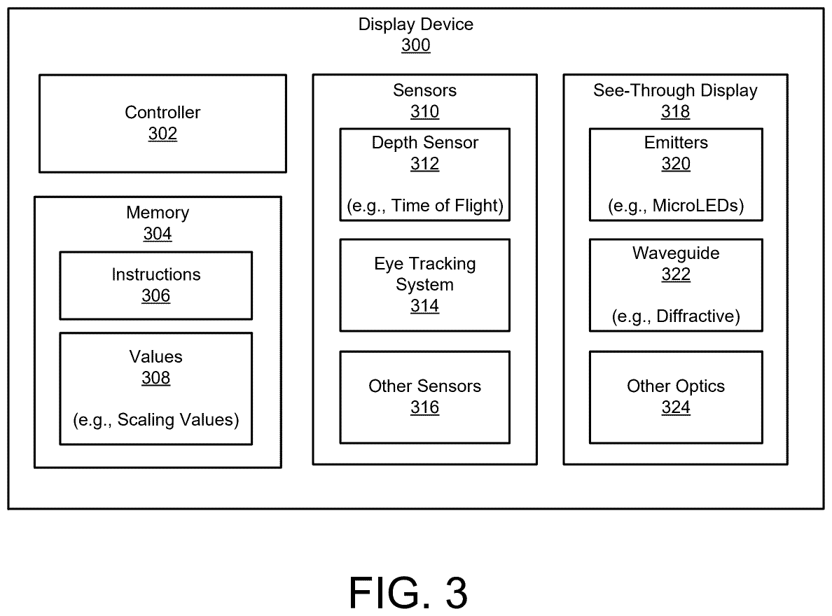

At operation 202, a process may be performed of determining a distance from a display device to a surface that is to be at least partially overlaid by virtual content in a field of view of the display device. This operation forms the primary input-gathering stage of the process, where the spatial relationship between the virtual content and the relevant real-world surface is quantified. This distance determined at operation 202 may be a variable that is measured in real-time by the display device. As will be described in more detail with reference to FIG. 3, this determination may be performed using various hardware components. For example, the distance may be determined based on data from an outward-facing depth sensor, or it may be determined based on data from an inward-facing eye tracking system, or a combination of both.

At operation 204, a process may be performed of determining, based on the distance, a size for the virtual content. This operation serves as a core computational step of method 200, where the controller calculates the specific size that will be used to render the virtual content to achieve the desired optical effect. The size is configured such that a depth of field for the virtual content extends at least from the surface to a focal plane at which the virtual content is to be displayed. The determination of the size at operation 204 may be performed in various ways. For example, the process may include determining a dioptric difference between a first diopter value associated with the focal plane and a second diopter value associated with the surface. A controller may then receive a scaling value from a data store that maps such dioptric differences to scaling values. The final size for the virtual content may then be determined based on this scaling value.

The specific outcome of the size determination at operation 204 may depend on the geometric relationship between the surface and the focal plane. For example, if the surface is either closer to the display device than the focal plane or farther from the display device than the focal plane, the size determined for the virtual content may be greater than a default size. This scaling up of the content expands its depth of field to bridge the gap. In another example, if the depth of field at a default size is determined to be unnecessarily large, the size determined for the virtual content may be less than the default size. This scaling down of the content can help to conserve display real estate. All of these types of scenarios will be further described and illustrated below.

At operation 206, the display device may display the virtual content at the focal plane with the size determined based on the distance at operation 204. This operation represents the final output of the process, where the size-modified virtual content is presented to the user. To perform this operation, a controller may control a plurality of emitters of the display device to generate light representing the virtual content with the appropriate size.

As further shown in FIG. 2, method 200 may also include an optional, ongoing monitoring process, which is represented by a dashed box for an operation 208. The dashed lines indicate that this part of the method may be performed to make the process dynamic and adaptive to changes in the environment.

At operation 208, a process may be performed of monitoring for a change in the distance from the display device to a surface that is to be at least partially overlaid by the virtual content. This monitoring can be continuous or periodic and allows the system to detect when the user has shifted their gaze, moved their head, or when a new surface at a different distance has moved behind the virtual content. As indicated by the feedback arrow from operation 208 back to operation 202, the system may be configured to react to the information gathered during monitoring. Specifically, the determining of the size for the virtual content at operation 204 may be performed in response to detecting the change in the distance. This responsive loop ensures that the size of the virtual content is always optimized for the current viewing context, providing a continuously comfortable and perceptually consistent visual experience for the user.

In summary, FIG. 2 illustrates a complete and logical method for implementing adaptive scaling of virtual content. By first determining a distance to a relevant real-world surface, then determining a size based on that distance, and finally displaying the size-modified content, method 200 provides a clear and effective technical solution to the problem of accommodation fatigue. The optional monitoring loop further illustrates how this solution can be made dynamic and responsive to a user's changing environment.

FIG. 3 shows a block diagram of an illustrative display device 300 configured for adaptive scaling for virtual content based on surface depth in accordance with principles described herein. The high-level display device 104 from FIG. 1 may be understood as an example implementation of the more detailed architecture of display device 300, which represents an apparatus configured to perform the methods and processes described herein, such as method 200. As illustrated, display device 300 may include various interconnected hardware and software components, which may be implemented within a single integrated system, such as a head-mounted display or a pair of AR glasses.

As shown, display device 300 may include a controller 302 and a memory 304. Controller 302 may be the central processing unit of display device 300, configured to orchestrate the operations of the various other components. Controller 302 may be implemented by one or more processors, such as a central processing unit (CPU), a graphics processing unit (GPU), an application-specific integrated circuit (ASIC), or another suitable processing unit. Memory 304 may be a non-transitory computer-readable medium, such as random-access memory (RAM) or flash memory, that is communicatively coupled to controller 302.

Memory 304 may be configured to store various data and instructions for use by controller 302. For example, memory 304 may store a set of instructions 306 that, when executed by controller 302, cause display device 300 to perform the operations described herein. Memory 304 may also store various values 308. For example, values 308 may include device-specific configuration data, such as a value representing the fixed distance to the focal plane of the device.

As part of determining the size for the virtual content, controller 302 may be configured to execute instructions 306 to determine a dioptric difference between a first diopter value associated with the distance to the focal plane and a second diopter value associated with the distance to the surface. In such implementations, values 308 stored in memory 304 may serve as a data store that maps a plurality of dioptric differences to a plurality of scaling values. Controller 302 may then be configured to receive a scaling value from this data store corresponding to the determined dioptric difference and use that scaling value to determine the final size for the virtual content.

Display device 300 may further include one or more sensors 310. Sensors 310 may be configured to gather data from the environment and/or from a user of display device 300, and to provide this data to controller 302. This data may be used, for example, to determine the second distance to a surface in the environment. As shown, sensors 310 may include a depth sensor 312, an eye tracking system 314, and other sensors 316.

Depth sensor 312 may be an outward-facing sensor configured to determine the distance to objects and surfaces in the environment. For example, depth sensor 312 may be configured to determine the distance to a surface based on a pose of the display device within the environment with respect to an object associated with the surface. In some implementations, depth sensor 312 may be a time-of-flight sensor configured to calculate the distance based on a time that a signal takes to travel from the display device to the surface. Data from depth sensor 312 may thus be used by controller 302 as a basis for determining the distance.

Eye tracking system 314 may be an inward-facing sensor system configured to analyze an eye of a user of the display device. For example, eye tracking system 314 may include one or more infrared cameras and illuminators. Controller 302 may use data generated by eye tracking system 314 to indicate that a gaze of the eye is directed to a surface of an object, and thereby identify that surface as the one for which the distance should be determined. In implementations where display device 300 is a binocular device, eye tracking system 314 may be configured to analyze two eyes of the user to determine a vergence angle, which can be used to determine the distance to an object that the user is currently looking at. In some implementations, data from eye tracking system 314 may be used in combination with additional data from depth sensor 312 to determine the distance.

Other sensors 316 may include any other sensors that may be useful for the operation of display device 300. For example, other sensors 316 may include an inertial measurement unit (IMU), which may be used to track the position and orientation (i.e., the pose) of display device 300. This pose information may be used by controller 302 in conjunction with data from depth sensor 312 to accurately determine the second distance.

Display device 300 may also include a see-through display 318. See-through display 318 is the primary output component of the device, configured to present virtual content to the user while also allowing the user to see their real-world environment. In some implementations, display device 300 may be a monocular display device, in which case see-through display 318 would be configured to direct light to present the virtual content to one eye of a user. In other implementations, display device 300 may be a binocular display device, in which case see-through display 318 would be configured to direct light to present the virtual content to both eyes of a user. See-through display 318 may include a plurality of emitters 320, a waveguide 322, and other optics 324.

The plurality of emitters 320 are the light-generating components of see-through display 318. Emitters 320 may be configured to generate light representing virtual content under the control of controller 302. In some implementations, the plurality of emitters 320 may include a plurality of micro light emitting diodes (microLEDs). In some cost-effective implementations that are particularly enabled by the content scaling techniques described herein, the plurality of microLEDs may form a monochrome panel in which each of the plurality of microLEDs is configured to generate light of a same single primary color (e.g., all green). This implementation is particularly enabled because the depth of field effect achieved by scaling the size of the content is a geometric optical effect that is independent of the content's color. Unlike other techniques that may rely on color manipulation, the content scaling method functions equally well with single-color content. This provides the technical benefit of allowing for a simpler and less expensive display hardware architecture, which could be a significant advantage for certain applications (e.g., industrial use cases) where full-color rendering is not required, and cost-effectiveness is a priority.

Waveguide 322 is an optical element configured to manipulate the light generated by the plurality of emitters 320. Specifically, waveguide 322 may be configured to receive the light from emitters 320 and direct it toward the user's eye, thereby displaying the virtual content at a focal plane. In some implementations, waveguide 322 includes a diffractive waveguide that includes a pair of incoupling gratings and outcoupling gratings and functions by selectively redirecting light from emitters 320.

Other optics 324 may represent any other optical components, such as lenses, coatings, or polarizers, that may be part of the optical path of see-through display 318. In some implementations, the optical system of display device 300 may be simplified by leveraging the software-based content scaling methods described herein, which may reduce the need for complex, active variable-focus components.

In overall operation, the components of display device 300 may interoperate as an integrated system to perform the adaptive content scaling. To provide a concrete example, display device 300 may be implemented as a head-mounted device worn by a user performing a task. Sensors 310 may gather real-time data about the distance to a physical object the user is manipulating. Controller 302, executing instructions 306 from memory 304, may process this sensor data to determine the distance, and then determine an appropriate size for virtual content comprising task instructions for the user. Controller 302 may then control the plurality of emitters 320 to display the virtual content with the determined size, with waveguide 322 directing the light to the user. This integrated operation allows display device 300 to function as an apparatus that provides a comfortable and clear viewing experience for the user.

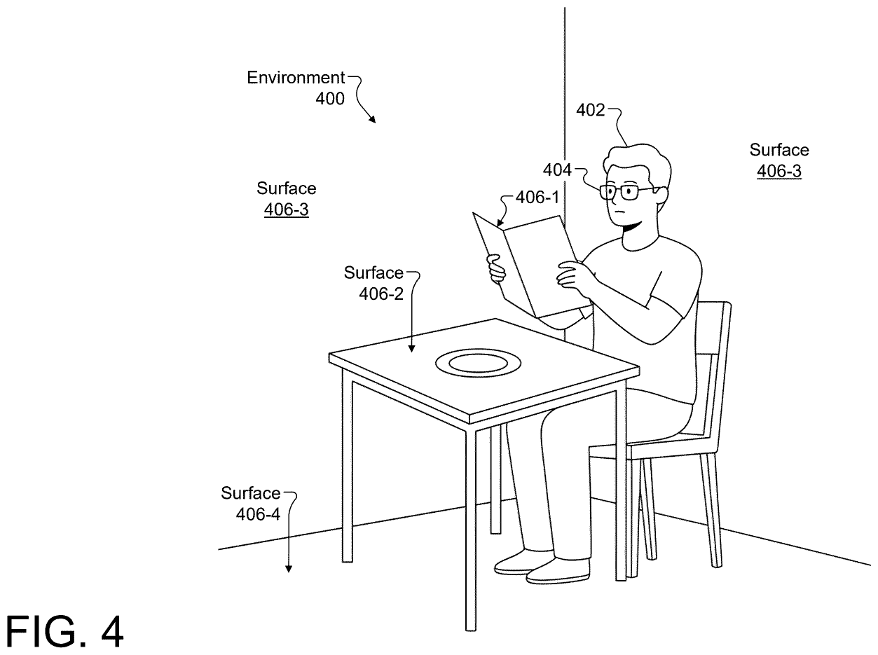

FIG. 4 shows an illustrative environment 400 for implementing adaptive scaling for virtual content based on surface depth in accordance with principles described herein. This figure provides a practical, real-world context to illustrate how the content scaling methods described herein can be applied in a dynamic setting with multiple potential surfaces of interest. As shown, the figure depicts a user 402 who is wearing and operating a display device 404. Display device 404 may be an example implementation of display device 300, as described with reference to FIG. 3.

Environment 400 may include various objects and surfaces at a range of different distances from user 402 and display device 404. For example, the figure illustrates several such surfaces, including a surface 406-1 of a handheld menu, a surface 406-2 of a tabletop, one or more surfaces 406-3 of the walls, and a surface 406-4 of the floor. Each of these surfaces represents a potential real-world surface that may be at least partially overlaid by virtual content, and thus each represents a potential distance that the system may need to account for when determining a size for the virtual content.

This figure may be used to illustrate the technical problem of accommodation fatigue in a concrete example. In the scenario shown, user 402 is holding a menu, and display device 404 is to overlay virtual content (e.g., a translation of the menu text) onto surface 406-1 of that menu. The distance from display device 404 to surface 406-1 may be quite small, such as approximately 30 or 40 centimeters. The optical system of display device 404, however, may have a fixed focal plane at a much greater distance, such as two meters (i.e., 200 centimeters). This significant mismatch between the distance to the focal plane and the distance to the surface would require user 402 to constantly re-accommodate their eyes to switch focus between the physical menu and the virtual translation, leading to eye strain.

To address this, display device 404 may perform methods and techniques described herein. For example, a controller of display device 404 may determine the distance to surface 406-1 (e.g., 0.4 m). Based on this distance being much closer than the focal plane (e.g., 2 m), the controller would then determine a size for the virtual content that is greater than a default size. This size increase expands the content's depth of field, allowing it to appear sharp to an eye that is accommodated for the near surface.

In some implementations, the system may operate using an outward-facing depth sensor to determine the distance. For example, a depth sensor on display device 404 may scan environment 400 to generate a depth map. When virtual content is to be displayed over the menu, the controller may identify that surface 406-1 is a surface within the display's field of view to be at least partially overlaid by the virtual content. The controller may then use the measured depth of surface 406-1 from the depth map as the distance for determining the size of the virtual content.

In other implementations, the system may operate using an eye tracking system. For example, an eye tracking system within display device 404 may be used to analyze an eye of user 402. The controller may identify the surface based on data generated by the eye tracking system that indicates a gaze of the eye is directed toward surface 406-1. This allows the system to confirm that the menu is the current object of interest for the user, and that the distance to surface 406-1 is the correct distance to use for the size determination process.

In yet other implementations, a controller of display device 404 may determine the distance to the relevant surface without needing to determine the specific gaze direction of user 402. For example, the controller may simply detect that the virtual content is visually occluding or registered with surface 406-1. The brain of user 402 may perceive the virtual content to be at the depth of surface 406-1 due to this powerful occlusion cue. Therefore, the controller can use the distance to surface 406-1 to determine the content size, providing the depth of field benefit automatically whenever user 402 looks at the close surface.

FIG. 4 also illustrates the dynamic nature of the system. For example, user 402 might put the menu down on the table, such that its surface is now at the distance of surface 406-2, and then shift their gaze to look at the wall at surface 406-3. Display device 404 may be configured to monitor for a change in the distance to a surface being overlaid by the virtual content. If new virtual content were to be displayed (e.g., a notification overlaid on the wall), the controller would detect the new, larger distance to surface 406-3. In response to detecting the change in the distance, the controller may determine a new size for the virtual content to match this new context.

In summary, FIG. 4 illustrates how a display device may intelligently adapt to a user's actions and focus within a complex real-world environment. By dynamically adjusting the size of virtual content based on the context provided by the various surfaces in the environment, the system can provide a continuously comfortable and perceptually coherent viewing experience.

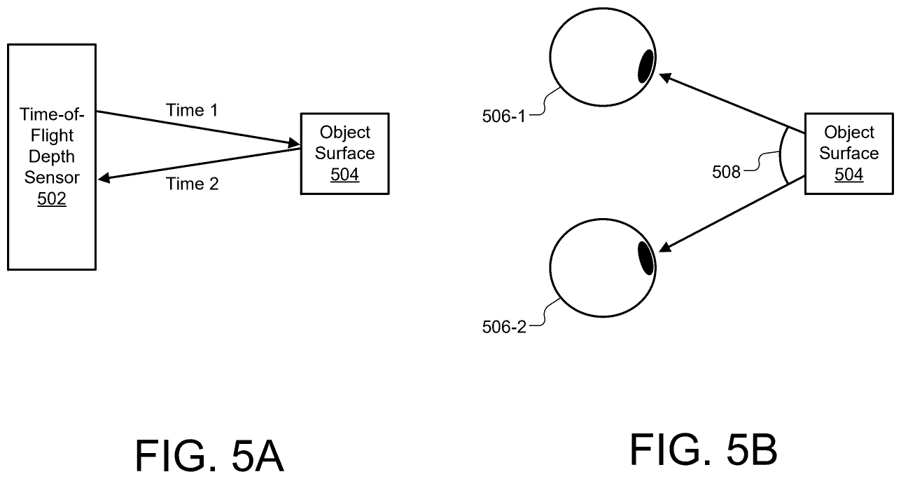

FIGS. 5A and 5B show aspects of illustrative techniques for determining a surface depth for adaptive scaling of virtual content in accordance with principles described herein. More specifically, these figures illustrate two example techniques that a display device may use, either individually or in combination, to determine the distance from a display device to a real-world surface in the environment (and onto which virtual content is to be at least partially overlaid). FIG. 5A illustrates a device-centric, active sensing technique, while FIG. 5B illustrates a user-centric technique based on physiological cues from the user's eyes.

Referring first to FIG. 5A, this figure illustrates an active sensing technique that may be used to determine a distance to an object surface 504. To perform this technique, a display device may include a time-of-flight depth sensor 502, which may be an example implementation of depth sensor 312 from FIG. 3. Object surface 504 may be any surface in the environment, such as surface 106 or any of surfaces 406-1 through 406-4 described previously.

FIG. 5A further illustrates the principle of operation of time-of-flight depth sensor 502. The sensor may be configured to emit a signal, such as a pulse of light (e.g., infrared light), that travels through the environment until it reflects off object surface 504. The reflected signal then travels back and is received by a detector on time-of-flight depth sensor 502. As illustrated, the time it takes for the signal to travel from the sensor to the surface is represented as “Time 1,” and the time it takes for the reflected signal to travel from the surface back to the sensor is represented as “Time 2.” A controller of the device may then calculate the distance to object surface 504 based on a time that the signal takes to travel from the display device to the surface. For example, the controller may calculate the distance based on the one-way travel time (e.g., Time 1) or the total round-trip travel time (Time 1+Time 2) and the known speed of the signal (i.e., the speed of light).

Referring now to FIG. 5B, this figure illustrates an alternative technique for determining the distance to object surface 504, based on the physiology of a user's visual system when the user's gaze is directed at the object (at whatever distance away it is). The figure depicts a user's two eyes, a first eye 506-1 and a second eye 506-2, as they focus on object surface 504. This technique is particularly applicable to binocular display devices that may include an eye tracking system.

The principle of binocular vergence is illustrated in this figure. When a user focuses on a nearby object, such as object surface 504, their eyes 506-1 and 506-2 naturally rotate inward (i.e., converge) to align their respective lines of sight on the object. The angle formed between these lines of sight is the vergence angle 508. As shown, vergence angle 508 may be at least roughly inversely proportional to the distance of object surface 504; a larger angle corresponds to a closer object, while a smaller angle corresponds to a more distant object. As such, the vergence angle may be used (e.g., along with other information such as an interpupillary distance or “IPD” of the user) to determine the distance in certain implementations.

To implement this technique, an eye tracking system may be configured to analyze the two eyes of the user. A controller may then determine the distance to the surface based on data generated by the eye tracking system. For example, the determining of the distance may include determining, based on the data generated by the eye tracking system, a vergence angle of the two eyes of the user, and then determining the distance based on the vergence angle. This provides another effective method for determining the distance, in this case based on the user's direct point of focus.

In some implementations, the techniques illustrated in FIGS. 5A and 5B may be used in combination to provide a more robust and accurate determination of the distance. For example, a system may use a depth sensor to generate a general depth map of the environment, and may also use an eye tracking system to determine which specific surface on that map the user's gaze is directed to. In such a case, the determining of the distance may be based on a combination of the data generated by the eye tracking system and additional data generated by the depth sensor.

FIG. 6 shows an illustrative diagram of a relationship between virtual content size and depth of field in accordance with principles described herein. This figure provides a conceptual illustration of the fundamental optical principle that is leveraged by the methods and systems described in this application. More specifically, the figure visually demonstrates that the depth of field for virtual content may be directly dependent on the size or scale of that content, a principle that enables the software-based mitigation of accommodation fatigue.

The diagram in FIG. 6 illustrates three distinct scenarios. A central, baseline scenario shows virtual content 602-1 (illustrated as a circle for this example, though the circle will be understood to represent any suitable virtual content such as text, a graphic, an animation, or the like, as may serve a particular implementation) being displayed at a default size. This default size is associated with a corresponding baseline depth of field 604-1. As has been defined, the depth of field represents the range of distances from a user's eye within which the virtual content will appear to be acceptably sharp to the user without the user needing to re-accommodate their eye. The extent of this range is represented by the width of the bar for depth of field 604-1.

A first alternative scenario, shown at the top of the figure, illustrates the effect of decreasing the size of the virtual content. As indicated by the arrow labeled “Scale Down,” when the virtual content is scaled down from the default size of virtual content 602-1 to a decreased size, shown as virtual content 602-2, its associated depth of field becomes narrower, as illustrated by the smaller depth of field 604-2. This illustrates the principle that smaller or more detailed content has a shallower depth of field and must be positioned more precisely at the user's exact accommodative distance to appear sharp.

A second alternative scenario, shown at the bottom of the figure, illustrates the effect of increasing the size of the virtual content. As indicated by the arrow labeled “Scale Up,” when the virtual content is scaled up from the default size of virtual content 602-1 to an increased size, shown as virtual content 602-3, its associated depth of field becomes wider, as illustrated by the larger depth of field 604-3. This illustrates an implication for technical solutions described herein: by making virtual content larger, the system can cause that content to remain in focus across a much broader range of distances.

The optical principle illustrated in FIG. 6 is related to the spatial frequency of the content as it is perceived by the eye. The human visual system has an inherently larger depth of field for objects with low spatial frequencies (i.e., coarse details) than it does for objects with high spatial frequencies (i.e., fine details). Scaling up an object, such as a piece of text, effectively lowers its spatial frequency from the perspective of the eye. This is because the same amount of detail is now spread over a larger angular size, making it a “coarser” visual stimulus. Because of this, the larger virtual content 602-3 is more forgiving of defocus and is perceived as having a greater depth of field 604-3.

In summary, FIG. 6 provides the fundamental scientific justification for the adaptive content scaling methods described herein. The direct and controllable relationship illustrated in the figure (i.e., that the size of virtual content determines its depth of field) will be understood as a technical mechanism that enables a display device to computationally determine and apply a specific size to virtual content to bridge the dioptric gap between its fixed focal plane and a variable real-world surface. This allows the system to achieve the technical effects of improved user comfort and a more seamless visual experience without requiring physical changes to the device's optics.

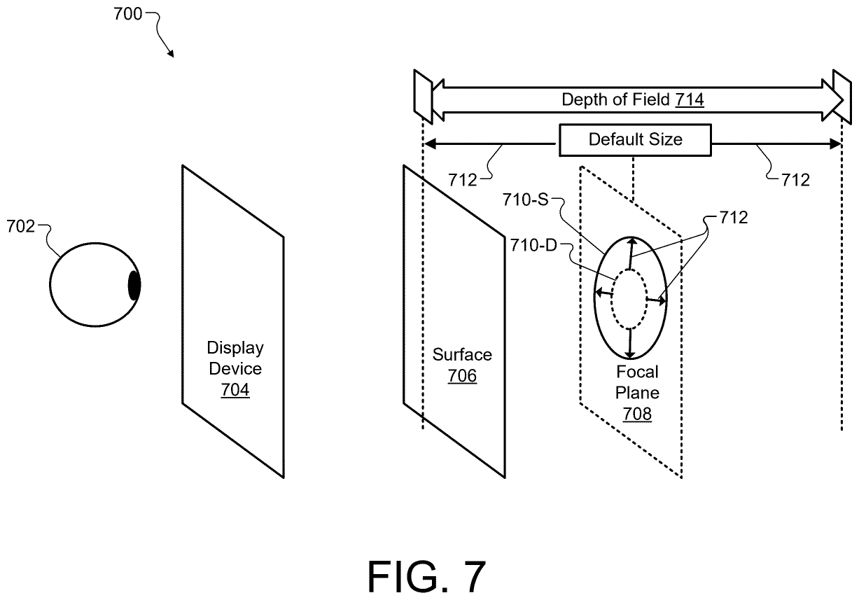

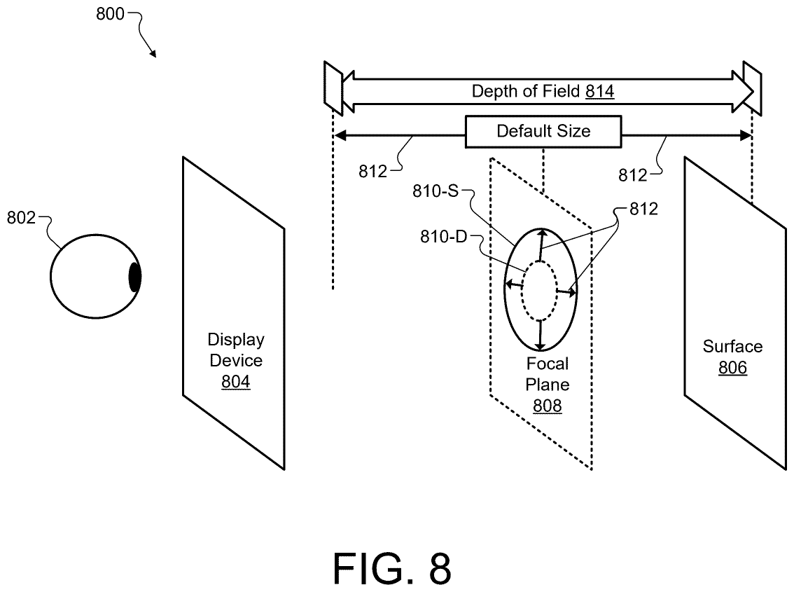

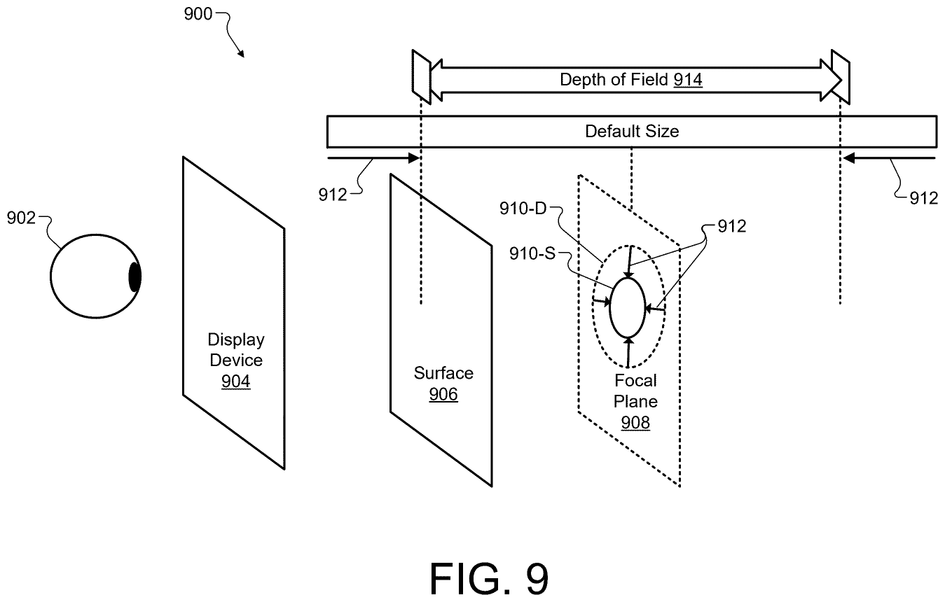

FIGS. 7-9 show several illustrative scenarios related to adaptive scaling for virtual content based on surface depth in accordance with principles described herein. This group of figures provides concrete, visual examples of three illustrative operational scenarios of the adaptive content scaling method to show how a display device may determine a size for virtual content to ensure its depth of field is appropriate for the real-world context. These figures use a consistent numbering scheme for corresponding elements to aid in understanding (e.g., an eye 702 in FIG. 7 corresponds to an eye 802 in FIG. 8 and an eye 902 in FIG. 9).

Referring first to FIG. 7, this figure illustrates a scenario 700, which depicts the application of the size determination process for a near surface (i.e., a surface nearer than the focal plane). The figure shows several components in a specific spatial layout, including an eye 702, a display device 704, a real-world surface 706, and a virtual focal plane 708. In the spatial layout for this scenario, surface 706 is positioned significantly closer to eye 702 than the device's fixed focal plane 708. This represents a situation where the distance from the display device to the surface is less than a distance from the display device to the focal plane.

Scenario 700 illustrates the application of technical solutions described herein for this configuration by depicting both an initial or default state of virtual content before a size determination is applied and further depicting a modified state of the virtual content (at an increased size) that is actually displayed. The initial or default state is represented using dotted lines, which depict virtual content 710-D at a default size. At this default size, the content has an inherent depth of field that may be insufficient for this scenario, as it would not extend far enough inward from focal plane 708 to encompass surface 706. Consequently, if a user were to focus their eye 702 on the nearby surface 706, the virtual content 710-D would appear blurry and out of focus, requiring the user to re-accommodate their eye to see it clearly.

To address this potential problem, display device 704 may be configured to perform the size determination techniques described herein. Specifically, a controller of display device 704, having determined that the distance to surface 706 is less than the distance to focal plane 708, may determine that the size of the virtual content should be larger than the default size. This size determination and its effect are represented in the figure by the scaling operation 712. First, the arrows of scaling operation 712 show the transformation of the content itself from the dotted-line virtual content 710-D at a default size to the larger, solid-line virtual content 710-S at a scaled size. Second, arrows labeled as part of scaling operation 712 conceptually illustrate the expansion of the depth of field from an initial, narrower range (suggested by the box labeled “Default Size” underneath depth of field 714) to the final, wider range represented by depth of field 714.

The resulting state after this size determination is illustrated by scaled virtual content 710-S and depth of field 714. Specifically, as a result of the size of the content being increased from the default, the associated depth of field is shown to expand inward (i.e., toward eye 702) from focal plane 708. This new, wider depth of field is represented by depth of field 714. The scaled size determined for the virtual content 710-S is specifically configured such that this new depth of field 714 now extends at least from focal plane 708 to surface 706, thereby bridging the dioptric gap between them. As a result, the size determined for the virtual content is greater than a default size of the virtual content. This allows the user to see both the real-world surface 706 and the virtual content 710-S in sharp focus simultaneously.

Referring now to FIG. 8, this figure illustrates a scenario 800, which depicts the application of the size determination process for a far surface (i.e., a surface farther from the eye than the focal plane). The figure shows corresponding components, including an eye 802, a display device 804, a surface 806, and a focal plane 808. In the spatial layout for this scenario, surface 806 is positioned significantly farther from eye 802 than the device's fixed focal plane 808. This represents a situation where the distance from the display device to the surface is greater than a distance from the display device to the focal plane.

Scenario 800 again illustrates the application of technical solutions for this far-surface configuration by depicting both the initial (default) state and the modified (scaled) state of the virtual content. The initial state is represented using dotted lines, which depict the virtual content 810-D at a default size. At this default size, the content has an inherent depth of field that is insufficient for this scenario, as it does not extend far enough outward from focal plane 808 to encompass the distant surface 806. If a user were to focus their eye 802 on the distant surface 806, the virtual content 810-D would appear blurry.

To address this, display device 804 may be configured to perform a similar size determination process. Based on the distance to surface 806 being greater than the distance to focal plane 808, the controller again determines that the size of the virtual content should be increased. This size determination and its effect are represented by the scaling operation 812. The arrows illustrate the transformation of the virtual content 810-D at a default size to the larger, solid-line virtual content 810-S at a scaled size. Other arrows labeled as part of scaling operation 812 also conceptually illustrate the corresponding expansion of the depth of field from an initial, narrower range (suggested by the “Default Size” box) to the final, wider range represented by depth of field 814.

The resulting state after this size determination is illustrated by scaled virtual content 810-S and depth of field 814. Specifically, as a result of the size increase, the associated depth of field expands outward (i.e., away from eye 802) from focal plane 808. This new, wider depth of field is represented by depth of field 814. The scaled size determined for the virtual content 810-S is specifically configured such that this new depth of field 814 now extends at least from focal plane 808 to surface 806. In this case as well, the size determined for the virtual content is greater than a default size of the virtual content. This allows the user to see both the distant real-world surface 806 and the virtual content 810-S in sharp focus simultaneously.

Referring now to FIG. 9, this figure illustrates a scenario 900, which depicts an optimization process for when the depth of field is unnecessarily large. The figure shows corresponding components, including an eye 902, a display device 904, a surface 906, and a focal plane 908. In the spatial layout for this scenario, surface 906 and focal plane 908 are positioned relatively close to one another.

Scenario 900 illustrates the application of technical solutions for this optimization case by depicting both the initial (default) state and the modified (scaled) state. The initial state that may trigger an optimization process is represented by the dotted lines, showing the virtual content 910-D at a default size. At this default size, the content has an inherent depth of field that is unnecessarily large for the scenario. Specifically, it would extend far beyond what is needed to cover a relatively small gap between surface 906 and focal plane 908. Using an unnecessarily large size for the virtual content can be inefficient in terms of display real estate, as it may obscure more of the user's view or leave less room for other virtual content.

Accordingly, to address this, display device 904 may be configured to perform an optimization process. The system may first determine that the depth of field for the virtual content, at a default size, extends to a location that is farther from the surface than the focal plane is. In response to this determination, the controller determines that the size of the content can be decreased without going out of focus for an eye accommodated to the relevant real-world surface. This optimization and its effect are represented by the scaling operation 912. The arrows illustrate the transformation from virtual content 910-D at a default size to a smaller, solid-line virtual content 910-S at a scaled size that may be determined by the system. Similar arrows labeled as part of scaling operation 912 also conceptually illustrate the corresponding contraction of the depth of field from an initial, wider range (suggested by the “Default Size” box) to the narrower range represented by depth of field 914.

The resulting state for this optimization scenario is also shown by virtual content 910-S and depth of field 914. As a result of the size decrease, the depth of field 914 shrinks to a narrower range. However, this narrower range is still sufficient to extend from focal plane 908 to surface 906, ensuring both remain in focus. The resulting virtual content 910-S is now smaller, which frees up display area for other content or provides the user with a less obstructed view of their environment. In this case, the size determined for the virtual content is less than the default size of the virtual content.

In summary, FIGS. 7-9 provide detailed visual support for the three operational modes of the adaptive scaling system. They demonstrate how the size of virtual content may be dynamically determined to be either larger or smaller than a default size to ensure its depth of field is always appropriate for the real-world context. The scenarios illustrate how this technique effectively mitigates accommodation fatigue by bridging the dioptric gap between a focal plane and a real-world surface, while also providing a mechanism to optimize the use of display area.

The size scaling described herein may be applied in a dynamic and context-dependent manner. As a user moves their head, shifts their gaze, moves around the environment, or as objects move within the environment, the distance to overlaid surfaces in the field of view of the display device may change, triggering corresponding changes in the determined size for the virtual content. The speed and magnitude of this size change may be configured based on the specific application or user preference. For example, in many implementations, the change in size may be performed substantially instantaneously. This rapid, snap-like transition may be preferable because it aligns with the brain's natural and instantaneous interpretation of occlusion cues. When virtual content begins to occlude a closer surface, the brain immediately perceives the virtual object as being closer, and an immediate increase in the object's size matches this new perceived distance, making the experience feel natural and consistent. In other implementations, however, a more gradual or animated transition may be used. For example, to avoid a potentially jarring “popping” effect as the content changes size, the scaling may be performed smoothly over a short duration (e.g., a few hundred milliseconds, a few seconds). This more subtle transition may be less noticeable to the user in certain contexts, such as when viewing aesthetic content rather than functional instructions.

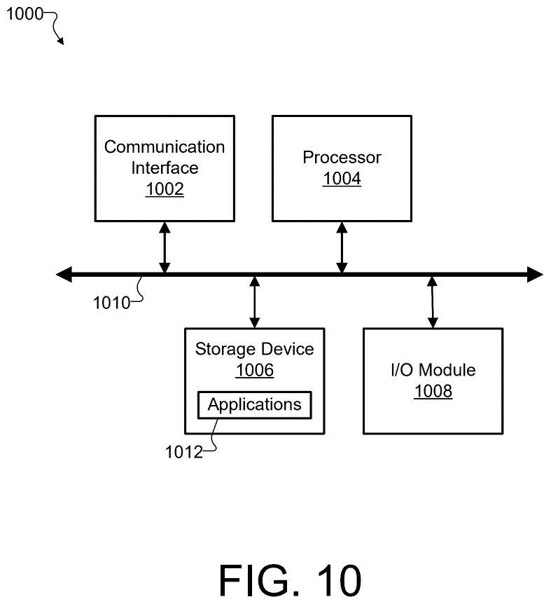

FIG. 10 shows a block diagram of an illustrative computing system 1000 for implementing adaptive scaling for virtual content based on surface depth in accordance with principles described herein. Computing system 1000 provides an example of a general-purpose computing environment that can be configured to perform the methods and processes described herein. For example, computing system 1000 may be used to implement the hardware of a display device, such as display device 300, or a controller thereof, such as controller 302.

As shown, computing system 1000 may include a communication interface 1002, a processor 1004, a storage device 1006, and an input/output (I/O) module 1008. These components may be communicatively connected via a communication infrastructure, such as a bus 1010, which facilitates data and control signal exchange between the various components. While a particular computing system 1000 is shown, it will be understood that the components illustrated are not intended to be limiting, as additional or alternative components may be included in other implementations.

Processor 1004 generally represents any type or form of processing unit capable of interpreting and executing instructions, such as those stored as applications 1012 in storage device 1006. For example, processor 1004 may be an implementation of controller 302 and may direct the execution of the methods described herein, such as method 200. Processor 1004 may include one or more central processing units (CPUs), one or more graphics processing units (GPUs), or a combination thereof.

Storage device 1006 may include one or more data storage media, devices, or configurations and may be an implementation of a non-transitory computer-readable medium. Storage device 1006 may include, without limitation, random-access memory (RAM), read-only memory (ROM), a hard drive, flash memory, or a combination thereof. Storage device 1006 is shown to store one or more applications 1012. Applications 1012 may represent computer-executable instructions that, when executed by processor 1004, cause computing system 1000 to perform the disclosed methods for adaptive scaling for virtual content. In addition, storage device 1006 may also be used to store other data, such as values 308, including the scaling values used to determine the size of the virtual content.

Communication interface 1002 may be configured to communicate with one or more other computing devices or networks, for example, to receive virtual content for presentation on a display. I/O module 1008 may be configured to receive input from various sensors, such as depth sensor 312 and eye tracking system 314, and to provide output signals to control display components, such as emitters 320.

In operation, the components of computing system 1000 may interoperate to perform the functions described herein. For example, processor 1004 may execute applications 1012 stored in storage device 1006. Executing the instructions may cause processor 1004 to receive sensor data via I/O module 1008, determine the appropriate distance and size for virtual content, and then control the display emitters via I/O module 1008 to perform the process of displaying the size-modified virtual content.

The following clauses describe implementations of adaptive scaling for virtual content based on surface depth in accordance with principles described herein.

Clause 1. A method comprising: determining a distance from a display device to a surface visible in a region of a field of view of the display device, the region being associated with virtual content to be displayed by the display device; determining, based on the distance, a configuration for at least a portion of the virtual content, the configuration being defined such that a depth of field for the virtual content extends at least from the surface to a focal plane at which the virtual content is to be displayed; and displaying, by the display device, the virtual content at the focal plane with the configuration determined based on the distance.

Clause 2. The method of clause 1, wherein: the surface is associated with an object in an environment in which the display device is operated; the display device includes a depth sensor configured to determine the distance based on a pose of the display device within the environment with respect to the object; and the determining of the distance from the display device to the surface is based on data generated by the depth sensor.

Clause 3. The method of clause 2, wherein the depth sensor is a time-of-flight sensor configured to: calculate the distance based on a time that a signal takes to travel from the display device to the surface; and generate the data to indicate the distance.

Clause 4. The method of clause 1, wherein: the configuration determined for at least the portion of the virtual content defines a size of the virtual content; the distance from the display device to the surface is less than a distance from the display device to the focal plane; and based on the distance to the surface being less than the distance to the focal plane, the configuration defines the size of the virtual content to be greater than a default size of the virtual content.

Clause 5. The method of clause 1, wherein: the configuration determined for at least the portion of the virtual content defines a size of the virtual content; the distance from the display device to the surface is greater than a distance from the display device to the focal plane; and based on the distance to the surface being greater than the distance to the focal plane, the configuration defines the size of the virtual content to be greater than a default size of the virtual content.

Clause 6. The method of clause 1, further comprising determining that the depth of field for the virtual content, at a default size, extends to a location that is farther from the surface than the focal plane is; wherein, in response to the determining that the depth of field extends to the location, the configuration determined for the virtual content defines a size of the virtual content that is less than the default size of the virtual content.

Clause 7. The method of clause 1, wherein: the display device includes an eye tracking system configured to analyze an eye of a user of the display device; and the determining of the distance from the display device to the surface includes identifying the surface based on data generated by the eye tracking system to indicate that a gaze of the eye is directed toward the surface.

Clause 8. The method of clause 7, wherein: the eye tracking system is configured to analyze two eyes of the user; and the determining of the distance from the display device to the surface includes: determining, based on the data generated by the eye tracking system, a vergence angle of the two eyes of the user; and determining the distance based on the vergence angle.

Clause 9. The method of clause 7, wherein: the display device further includes a depth sensor configured to determine the distance from the display device to the surface; and the determining of the distance from the display device to the surface is based on a combination of the data generated by the eye tracking system and additional data generated by the depth sensor.

Clause 10. The method of clause 1, wherein the configuration determined for at least the portion of the virtual content defines a size of the virtual content and the determining of the configuration for the virtual content includes: determining a dioptric difference between a first diopter value associated with a distance from the display device to the focal plane and a second diopter value associated with the distance from the display device to the surface; receiving a scaling value from a data store that maps a plurality of dioptric differences to a plurality of scaling values, the scaling value received from the data store corresponding to the dioptric difference; and determining the size for the virtual content based on the scaling value received from the data store.

Clause 11. The method of clause 1, further comprising monitoring for a change in the distance from the display device to the surface visible in the region of the field of view associated with the virtual content; wherein the determining of the configuration for at least the portion of the virtual content is performed in response to detecting the change in the distance.

Clause 12. The method of clause 1, wherein: the display device is a head-mounted display device configured provide an extended reality experience to a user wearing the head-mounted display device; and the virtual content comprises instructions for performing a task associated with manipulating an object in an environment of the user.

Clause 13. An apparatus comprising: a plurality of emitters configured to generate light representing virtual content; a waveguide configured to manipulate the light generated by the plurality of emitters to display the virtual content at a focal plane; and a controller configured to: determine a distance to a surface visible in a region of a field of view of the apparatus, the region being associated with virtual content to be displayed by the apparatus; determine, based on the distance, a configuration for at least a portion of the virtual content, the configuration being defined such that a depth of field for the virtual content extends at least from the surface to the focal plane; and control the plurality of emitters to display the virtual content at the focal plane with the configuration determined based on the distance.

Clause 14. The apparatus of clause 13, wherein: the apparatus is a monocular display device configured to present the virtual content to one eye of a user; and the waveguide includes a diffractive waveguide configured to direct the light generated by the plurality of emitters to present the virtual content to the one eye.

Clause 15. The apparatus of clause 13, wherein: the plurality of emitters includes a plurality of micro light emitting diodes (microLEDs); and the plurality of microLEDs form a monochrome panel in which each of the plurality of microLEDs is configured to generate light of a same single primary color.

Clause 16. The apparatus of clause 13, further comprising a time-of-flight depth sensor configured to: calculate the distance based on a time that a signal takes to travel from the apparatus to the surface; and generate data indicating the distance to the surface; wherein the controller is configured to determine the distance from the apparatus to the surface based on the data generated by the time-of-flight depth sensor.

Clause 17. The apparatus of clause 13, wherein: the apparatus is a head-mounted display device configured to provide an extended reality experience to a user wearing the head-mounted display device; and the controller is configured to control the plurality of emitters to display the virtual content that comprises instructions for performing a task associated with manipulating an object in an environment of the user.

Clause 18. A non-transitory computer-readable medium storing instructions that, when executed, cause a controller of a display device to perform a process comprising: determining a distance from the display device to a surface visible in a region of a field of view of the display device, the region being associated with virtual content to be displayed by the display device; determining, based on the distance, a configuration for at least a portion of the virtual content, the configuration being defined such that a depth of field for the virtual content extends at least from the surface to a focal plane at which the virtual content is to be displayed; and causing the display device to display the virtual content at the focal plane with the configuration determined based on the distance.

Clause 19. The non-transitory computer-readable medium of clause 18, wherein: the configuration determined for at least the portion of the virtual content defines a size of the virtual content; the distance from the display device to the surface is less than a distance from the display device to the focal plane; and based on the distance to the surface being less than the distance to the focal plane, the configuration defines the size of the virtual content to be greater than a default size of the virtual content.

Clause 20. The non-transitory computer-readable medium of clause 18, wherein the process further comprises determining that the depth of field for the virtual content, at a default size, extends to a location that is farther from the surface than the focal plane is; wherein, in response to the determining that the depth of field extends to the location, the configuration determined for the virtual content defines a size of the virtual content that is less than the default size of the virtual content.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. It will be understood that various modifications may be made without departing from the spirit and scope of the description and claims. The described implementations are examples, and that other systems can be used to perform similar functions. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the implementations of the disclosure.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the term “comprising,” when used in this specification, specifies the presence of the stated features, steps, operations, elements, and/or components, but does not preclude the presence or addition of one or more other features, steps, operations, elements, components, and/or groups thereof.

It will be understood that when an element is referred to as being “coupled” or “connected” to another element, it can be directly coupled or connected to the other element, or intervening elements may also be present. In contrast, when an element is referred to as being “directly coupled” or “directly connected” to another element, there are no intervening elements present.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Further to the descriptions above, a user may be provided with controls allowing the user to make an election as to both if and when systems, programs, or features described herein may enable collection of user information (e.g., information about a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, such as to a city, zip code, or state level, so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
determining a distance from a display device to a surface visible in a region of a field of view of the display device, the region being associated with virtual content to be displayed by the display device;
determining, based on the distance, a configuration for at least a portion of the virtual content, the configuration being defined such that a depth of field for the virtual content extends at least from the surface to a focal plane at which the virtual content is to be displayed; and
displaying, by the display device, the virtual content at the focal plane with the configuration determined based on the distance.

2. The method of claim 1, wherein:
the surface is associated with an object in an environment in which the display device is operated;
the display device includes a depth sensor configured to determine the distance based on a pose of the display device within the environment with respect to the object; and
the determining of the distance from the display device to the surface is based on data generated by the depth sensor.

3. The method of claim 2, wherein the depth sensor is a time-of-flight sensor configured to:
calculate the distance based on a time that a signal takes to travel from the display device to the surface; and
generate the data to indicate the distance.

4. The method of claim 1, wherein:
the configuration determined for at least the portion of the virtual content defines a size of the virtual content;
the distance from the display device to the surface is less than a distance from the display device to the focal plane; and
based on the distance to the surface being less than the distance to the focal plane, the configuration defines the size of the virtual content to be greater than a default size of the virtual content.

5. The method of claim 1, wherein:
the configuration determined for at least the portion of the virtual content defines a size of the virtual content;
the distance from the display device to the surface is greater than a distance from the display device to the focal plane; and
based on the distance to the surface being greater than the distance to the focal plane, the configuration defines the size of the virtual content to be greater than a default size of the virtual content.

6. The method of claim 1, further comprising determining that the depth of field for the virtual content, at a default size, extends to a location that is farther from the surface than the focal plane is;
wherein, in response to the determining that the depth of field extends to the location, the configuration determined for the virtual content defines a size of the virtual content that is less than the default size of the virtual content.

7. The method of claim 1, wherein:
the display device includes an eye tracking system configured to analyze an eye of a user of the display device; and
the determining of the distance from the display device to the surface includes identifying the surface based on data generated by the eye tracking system to indicate that a gaze of the eye is directed toward the surface.

8. The method of claim 7, wherein:
the eye tracking system is configured to analyze two eyes of the user; and
the determining of the distance from the display device to the surface includes:
determining, based on the data generated by the eye tracking system, a vergence angle of the two eyes of the user; and
determining the distance based on the vergence angle.

9. The method of claim 7, wherein:
the display device further includes a depth sensor configured to determine the distance from the display device to the surface; and
the determining of the distance from the display device to the surface is based on a combination of the data generated by the eye tracking system and additional data generated by the depth sensor.

10. The method of claim 1, wherein the configuration determined for at least the portion of the virtual content defines a size of the virtual content and the determining of the configuration for the virtual content includes:
determining a dioptric difference between a first diopter value associated with a distance from the display device to the focal plane and a second diopter value associated with the distance from the display device to the surface;
receiving a scaling value from a data store that maps a plurality of dioptric differences to a plurality of scaling values, the scaling value received from the data store corresponding to the dioptric difference; and
determining the size for the virtual content based on the scaling value received from the data store.

11. The method of claim 1, further comprising monitoring for a change in the distance from the display device to the surface visible in the region of the field of view associated with the virtual content;
wherein the determining of the configuration for at least the portion of the virtual content is performed in response to detecting the change in the distance.

12. The method of claim 1, wherein:
the display device is a head-mounted display device configured provide an extended reality experience to a user wearing the head-mounted display device; and
the virtual content comprises instructions for performing a task associated with manipulating an object in an environment of the user.

13. An apparatus comprising:
a plurality of emitters configured to generate light representing virtual content;
a waveguide configured to manipulate the light generated by the plurality of emitters to display the virtual content at a focal plane; and
a controller configured to:
determine a distance to a surface visible in a region of a field of view of the apparatus, the region being associated with virtual content to be displayed by the apparatus;
determine, based on the distance, a configuration for at least a portion of the virtual content, the configuration being defined such that a depth of field for the virtual content extends at least from the surface to the focal plane; and
control the plurality of emitters to display the virtual content at the focal plane with the configuration determined based on the distance.

14. The apparatus of claim 13, wherein:
the apparatus is a monocular display device configured to present the virtual content to one eye of a user; and
the waveguide includes a diffractive waveguide configured to direct the light generated by the plurality of emitters to present the virtual content to the one eye.

15. The apparatus of claim 13, wherein:
the plurality of emitters includes a plurality of micro light emitting diodes (microLEDs); and
the plurality of microLEDs form a monochrome panel in which each of the plurality of microLEDs is configured to generate light of a same single primary color.

16. The apparatus of claim 13, further comprising a time-of-flight depth sensor configured to:
calculate the distance based on a time that a signal takes to travel from the apparatus to the surface; and
generate data indicating the distance to the surface;
wherein the controller is configured to determine the distance from the apparatus to the surface based on the data generated by the time-of-flight depth sensor.

17. The apparatus of claim 13, wherein:
the apparatus is a head-mounted display device configured to provide an extended reality experience to a user wearing the head-mounted display device; and
the controller is configured to control the plurality of emitters to display the virtual content that comprises instructions for performing a task associated with manipulating an object in an environment of the user.

18. A non-transitory computer-readable medium storing instructions that, when executed, cause a controller of a display device to perform a process comprising:
determining a distance from the display device to a surface visible in a region of a field of view of the display device, the region being associated with virtual content to be displayed by the display device;
determining, based on the distance, a configuration for at least a portion of the virtual content, the configuration being defined such that a depth of field for the virtual content extends at least from the surface to a focal plane at which the virtual content is to be displayed; and
causing the display device to display the virtual content at the focal plane with the configuration determined based on the distance.

19. The non-transitory computer-readable medium of claim 18, wherein:
the configuration determined for at least the portion of the virtual content defines a size of the virtual content;
the distance from the display device to the surface is less than a distance from the display device to the focal plane; and
based on the distance to the surface being less than the distance to the focal plane, the configuration defines the size of the virtual content to be greater than a default size of the virtual content.

20. The non-transitory computer-readable medium of claim 18, wherein the process further comprises determining that the depth of field for the virtual content, at a default size, extends to a location that is farther from the surface than the focal plane is;
wherein, in response to the determining that the depth of field extends to the location, the configuration determined for the virtual content defines a size of the virtual content that is less than the default size of the virtual content.
